(19) United States
(12) Patent Application Publication
(10) Pub. No.: US 2012/0274651 A1
(43) Pub. Date: Nov. 1, 2012

(54) MATRIX DISPLAY DEVICE FOR DISPLAYING TWO MERGED IMAGES

(75) Inventors: Gunther HASS, SAINT EGREVE (FR); Laurent ESPUNO, LE FONTANIL (FR)

(73) Assignee: MICROOLED, GRENOBLE CEDEX (FR)

(21) Appl. No.: 13/278,920

(22) Filed: Oct. 21, 2011

(30) Foreign Application Priority Data
Oct. 22, 2010 (FR) 1058684

(51) Int. Cl. G09G 5/00; G09G 5/02

(52) U.S. Cl. 345/589

(57) ABSTRACT

A matrix display device with a definition determined by a plurality of pixels, the matrix display device including at least one controller suitable for producing display light intensity signals for each of the pixels; and a matrix of pixels organized in a mosaic of a plurality of identical arrangements of a determined number of pixels, wherein a first number of pixels of an arrangement are dedicated to display of a first image and receives the light intensity signals associated with the pixels of the first image that correspond thereto, one or more other pixels of the arrangement are dedicated to display of a second image and receiving light intensity signals associated with the pixels of said second image that correspond thereto, the matrix display device producing the merged display of the first image and of the second image, the two images being, if necessary, redimensioned by scaling means.

### CROSS-REFERENCE TO RELATED APPLICATION

This application claims priority to foreign French patent application No. FR 10 58684, filed on Oct. 22, 2010, the disclosure of which is incorporated by reference in its entirety.

### FIELD OF THE DISCLOSED SUBJECT MATTER

The present invention relates to a matrix display device for displaying two merged images. It applies more particularly to the simultaneous display of two images whose definitions may differ.

### BACKGROUND

Some applications involving the display of images involve a need for a merging of images, that is to say a simultaneous display of two images originating from two different sources. The two sources may notably originate from two image sensors of different natures, aiming to restore information of different natures on one and the same scene. For example, it may prove necessary to enable the display of a first image, for example in grey levels and in high definition, produced by a first high definition sensor, simultaneously with a second image, of lesser definition, and typically monochrome or two-color, for example produced by a second sensor. These two images may, for example, correspond respectively to a first image restored by a night vision sensor and a second image restored by an infrared sensor; or even to a first image restored by X-ray radiography, and a second image produced by magnetic resonance imaging. In the abovementioned two cases, the images represent one and the same scene. Also, the first image may represent a scene restored by a high definition sensor, and the second image may represent symbols, text or even menus that have to be displayed simultaneously with the first image.

The present invention relates to the abovementioned applications, as nonlimiting examples, and may also be applied to other examples. More particularly, the present invention relates to the merging of images for a display via a matrix display device. A matrix display device is essentially formed by a matrix of pixels, associated with an addressing system; active matrix and passive matrix systems are known from the prior art. The pixels may, for example, be formed by liquid crystals, commonly designated by the acronym LCD, standing for “Liquid Crystal Display”, or even by light-emitting diodes, or LEDs, or even by organic light-emitting diodes, commonly designated by the acronym OLED. The matrix of pixels is usually associated with a controller, formatting the video signal and generating the control signals intended for the matrix. Hereinafter, it can be assumed, in the interests of simplicity, that a control signal is limited to a light intensity signal, that can be likened to a quantified and standardized value, that may, for example, be a voltage value to be applied to a light-emitting element, or a numeric value, for example coded on 8 bits and thus between 0 and 255, intended for a matrix or for a numeric pixel. It may, for example, be understood that the signals applied are luminance signals, for which the magnitudes vary from a zero value corresponding to a black level, to a maximum value. The formation of an image on a display device, by the application of appropriate signals to the pixels, can be referred to by the term “mapping”. The controller may, for example, be implemented in an integrated electronic circuit of ASIC type, the acronym standing for “Application Specific Integrated Circuit”. The controller may also, for example, be implemented via a programmable microcontroller. The controller may also, for example, be implemented via a programmable component of FPGA type, the acronym standing for “Field-Programmable Gate Array”, of EPLD type, the acronym standing for “Erasable Programmable Logic Device”, or other known types of programmable components.

The devices known from the prior art that make it possible to display merged images as in the examples described above, usually proceed with a display on a polychrome screen, typically of the type commonly designated by the acronym RGB, the acronym referring to the three colors Red, Green, Blue, forming, by combination, all the visible colors, of a merged image generated by a computer, implemented in a dedicated logic circuit, or else via software run on a powerful computer. The merging algorithms may be relatively complex, and the definition of the merged image is significantly degraded, the latter being displayed on a polychrome screen, and being essentially composed of the first monochrome image. In practice, the polychrome display matrices are usually made up of a plurality of groups of pixels or “sub-pixels”, a sub-pixel being dedicated to the display of a basic color, for example by being associated with a color filter, or else by being formed by a luminescent element suitable for producing different colored light signals. Typically, a group may consist of three sub-pixels: each of the pixels being associated with a filter of a basic color, the group then making it possible to display the desired color from a palette of colors, by combination of the sub-pixel control signals. It is, for example, usual practice to employ arrangements of sub-pixels respectively associated with red, green and blue color filters.

### SUMMARY

One aim of the present invention is to overcome at least the abovementioned drawbacks, by proposing a matrix display device for displaying two merged images, that best preserves the definition of the image that has the higher definition.

One advantage of the invention is that it makes it possible to implement algorithms, the implementation of which is facilitated, and can, for example, be carried out by the controller of the matrix display.

To this end, the subject of the invention is a matrix display device with a definition determined by a plurality of pixels, the matrix display device comprising:
at least one controller suitable for producing display light intensity signals for each of the pixels, and
a matrix of pixels organized in a mosaic of a plurality of identical arrangements of a predetermined number of pixels, wherein a first plurality of pixels of one of the arrangements are dedicated to display of a first image and receive the light intensity signals associated with the pixels of the first image (I1) that correspond thereto, one or more other pixels of the arrangement are dedicated to the display of a second image (I2) and receiving light intensity signals associated with the pixels of said second image (I2) that correspond thereto, the matrix display device producing the merged display of the first image (I1) and of the second image (I2), the two images (I1, I2) being, if necessary, redimensioned by scaling means.

In one embodiment of the invention, each of said arrangements can be formed by a square of four pixels: three pixels of each arrangement being associated with the light intensity signals intended for the corresponding pixels of the first image, and the remaining pixel being associated with the light intensity signal intended for the corresponding pixel of the second image.

In one embodiment of the invention, each of said arrangements can be formed by a square of four pixels: two pixels of each arrangement being associated with the light intensity signals intended for the corresponding pixels of the first image, and the remaining two pixels being associated with the light intensity signals intended for the corresponding pixels of the second image.

In one embodiment of the invention, the pixels dedicated to the display of the first image can emit a first single color, the pixels dedicated to the display of the second image being able to emit a second single color different from the first color.

In one embodiment of the invention, said remaining pixels of the display device can be configured to display two colors which, by combination, make it possible to restore the color associated with the first pixel.

In one embodiment of the invention, the controller can be configured to apply to said three pixels of the arrangements for which said remaining pixels have a quantified light intensity signal value greater than a predetermined threshold value, an attenuation function attenuating the quantified values of the signals to be applied.

In one embodiment of the invention, the attenuation function can attenuate the quantified values of the light intensity signals to be applied respectively to said three pixels Si, according to the following relationship:

Si=b·exp(−a·S1i)·S1i

for i=1; 3; 4, a and b being real parameters, S1i being the quantified values of the light intensity signals of the corresponding pixels of the first image.

In one embodiment of the invention, the controller can be configured to apply, to said two pixels of the arrangements for which said remaining pixels have a quantified light intensity signal value greater than a predetermined threshold value, an attenuation function attenuating the quantified values of the signals to be applied.

In one embodiment of the invention that is dependent on the preceding embodiment, the attenuation function can attenuate the quantified values of the light intensity signals to be applied respectively to said two pixels, according to the following relationship:

Si=b·exp(−a·S1i)·S1i

for i=1; 4, a and b being real parameters.

In one embodiment of the invention, said remaining pixels of the display device are configured to display two colors which, by combination, make it possible to restore the color associated with the first image.

In one embodiment of the invention, the controller can be configured to apply, to said remaining two pixels of each of the arrangements of the display device for which the pixels of the arrangements of said second image that correspond thereto have a quantified light intensity signal value less than a determined threshold, values derived from a combination of the quantified values of the light intensity signals of the first image, according to the following relationships:

S2=a*(S12+S13)/2,

S3=b*(S12+S13)/2;

a and b being real parameters, the sum of which equals 2.

In one embodiment of the invention, the matrix display device can include a first controller interfacing with said first number of pixels of each arrangement and corresponding to the first image, and a second controller interfacing with the other pixels of each arrangement and corresponding to said second image.

According to various embodiments of the invention, the matrix display device can be configured to display a first image, essentially monochrome, produced by a night vision sensor or by an infrared sensor or by an X-ray imaging sensor, merged with the display of a second image, essentially monochrome, produced by an infrared sensor, by an echography sensor, or a monochrome or two-color symbology image.

### BRIEF DESCRIPTION OF THE DRAWINGS

Other features and advantages of the invention will become apparent from reading the description, given by way of example, in light of the appended drawings which represent:

FIG. 1, a diagram giving a synoptic presentation of the general principle of a matrix display device, in an exemplary embodiment of the invention;

FIG. 2, a diagram giving a synoptic presentation of the display produced by an arrangement of pixels, in a first exemplary embodiment of the invention;

FIG. 3, a diagram giving a synoptic presentation of the display produced on an arrangement of pixels, in a second exemplary embodiment of the invention;

FIG. 4, a diagram presenting an exemplary embodiment of a matrix display device according to one embodiment of the invention.

### DETAILED DESCRIPTION

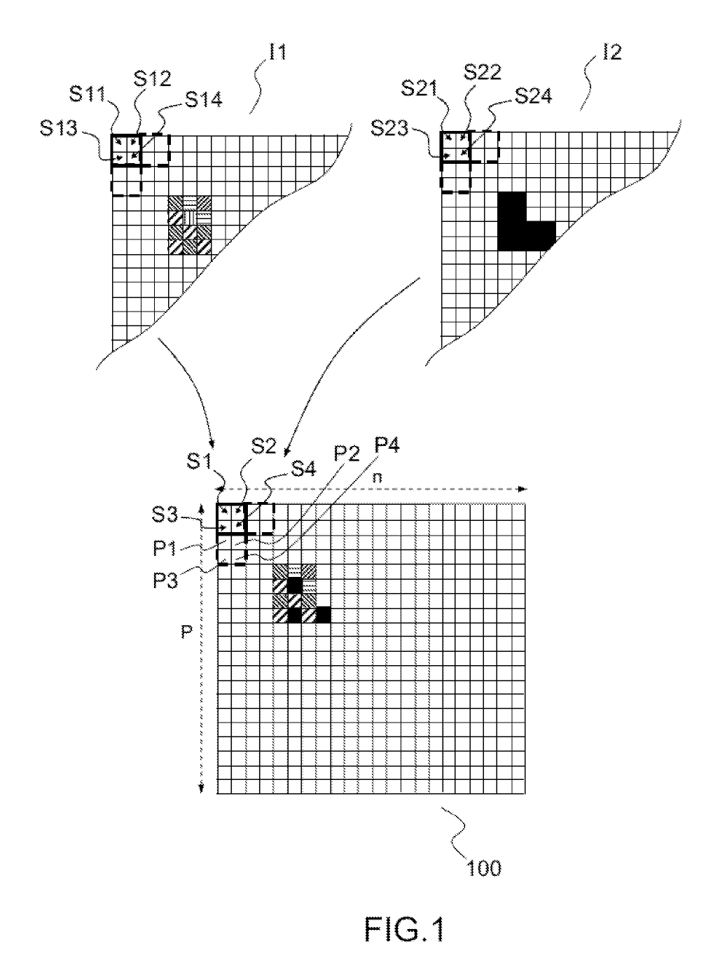

FIG. 1 is a diagram presenting a synoptic illustration of the general principle of a matrix display device according to an exemplary embodiment of the present invention.

A first image I1 is partially illustrated in FIG. 1, the first image I1 having first, if necessary, been redimensioned so as to offer a definition identical to the definition of the matrix of pixels of a display device 100. In the example illustrated in FIG. 1, the matrix of pixels of the display device 100 is rectangular, with n columns and p rows of pixels. The present invention can also be applied to matrices of different forms. The display device 100 may, for example, be a display of OLED, or LED, or LCD type, or of any other known type, associated with a controller which is not represented in FIG. 1.

Similarly, a second image I2 is partially illustrated in FIG. 1, this also having, if necessary, been redimensioned so as to offer a definition identical to that of the matrix of pixels of the display device 100, or else to a definition corresponding to a subdefinition of that of the matrix of pixels of the display device 100, for example, a quarter thereof.

The redimensioning, sometimes referred to by the term “upscaling” if the native definition of the image is lower than the definition of the display, or else by the term “downscaling” in the opposite case, can, for example, be implemented by a microcontroller which is not represented in FIG. 1, according to methods which are intrinsically known from the prior art and not explained in the present description.

According to a specific feature of the present invention, a mosaic may be considered, this mosaic covering all the pixels of the two images I1, I2 and the matrix of the display device 100, and being formed by a plurality of identical arrangements of pixels. In the example illustrated in FIG. 1 and the subsequent figures, a square arrangement of four pixels P1, P2, P3, P4 is considered. The present invention can, obviously, be applied with arrangements of a plurality of pixels, the number of which may differ from four, the form of the arrangements not necessarily being square or rectangular, provided that the arrangements as a whole can cover all the pixels considered.

The merged image resulting from the two images I1, I2 can be formed via appropriate light intensity signals. Thus, the light intensity signals that make it possible to form the pixels P1, P2, P3, P4 of an arrangement of pixels of the merged image can be respectively denoted S1, S2, S3, S4. The light intensity signals that make it possible to form the corresponding four pixels of the arrangement of the first image I1 alone can be denoted S11, S12, S13, S14, and, similarly, the light intensity signals that make it possible to form the four pixels of the arrangement of the second image I2 that correspond thereto can be denoted S21, S22, S23, S24.

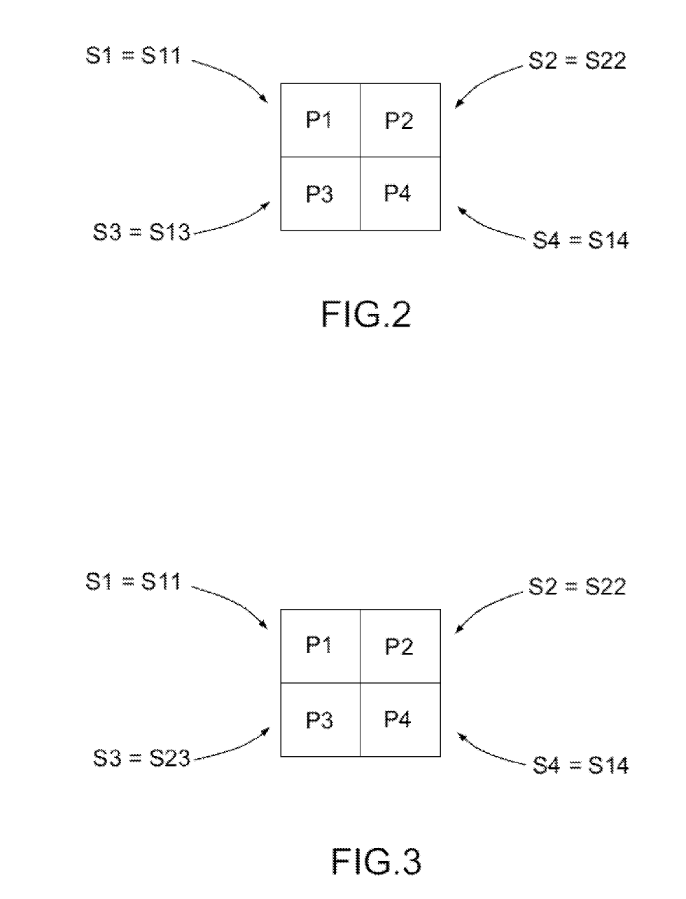

The present invention proposes that each pixel P1, P2, P3, P4 of an arrangement of pixels of the merged image be formed either via a light intensity signal S11, S12, S13, S14 that makes it possible to form the first image I1, or via a light intensity signal S21, S22, S23, S24 that makes it possible to form the second image I2, or via a light intensity signal resulting from a combination of the abovementioned signals S11, S12, S13, S14 and S21, S22, S23, S24 that makes it possible to respectively form the first image I1 and the second image I2. Thus, a first number of pixels of an arrangement may receive light intensity signals associated with the pixels of the first image I1 that correspond thereto, and the other pixels of the arrangement may receive the light intensity signals associated with the pixels of the second image I2 that correspond thereto, or light intensity signals determined by a combination of the light intensity signals associated with the pixels of the two images I1, I2. Different examples of arrangements of pixels are described hereinbelow, notably with reference to FIGS. 2 and 3; it should be noted that these examples are in no way limiting on the present invention, and that other arrangements of pixels can be envisaged.

FIG. 2 is a diagram presenting a synoptic illustration of the display of two merged images produced on an exemplary arrangement of pixels, according to a first possible embodiment of the invention.

FIG. 2 presents an arrangement of four pixels P1, P2, P3, P4. For each arrangement of pixels, it is, for example, possible to reserve for a first pixel, for example for the first pixel P1 of the matrix of the display device, the light intensity signal S11 that makes it possible to display the first pixel P1 of the first image. It is possible to also reserve for two other pixels, for example for the third and fourth pixels P3, P4 of the matrix of the display device, the light intensity signals S13 and S14 that respectively make it possible to display the third and fourth pixels of the first image. Finally, it is possible to reserve for the last pixel of the arrangement, that is to say, for example, for the second pixel P2 of the matrix of the display device, the light intensity signal S22 that makes it possible to display the second pixel P2 of the second image. Such an exemplary arrangement is particularly suited to the cases where the second image is monochrome. In this exemplary embodiment, the second pixel P2, for each arrangement of the matrix of the display device, can be associated with a colored filter.

Practically, the display of the duly merged image can, for example, be implemented via the following operations, performed by means of the controller of the display device:
a first operation of mapping the first image to the display device, the controller then applying the light intensity signals S11, S13 and S14 respectively to the first, third and fourth pixels P1, P3, P4 of all the arrangements of pixels forming the display device;
a second operation of mapping the second image to the display device, the controller then applying the light intensity signal S22 to the second pixels P2 of all the arrangements of pixels forming the display device. It can be seen here that the mapping of the second image I2 to the display device is produced on a definition corresponding to the number of pixels intended for the display of the second image I2; that is to say, in the case of the example described here, the pixels P2 being assigned to the display of the image I2, on a quarter of the definition of the matrix of the display device.

FIG. 3 is a diagram presenting a synoptic illustration of the display of two merged images produced on an exemplary arrangement of pixels, according to a second possible embodiment of the invention.

FIG. 3 presents an arrangement of four pixels P1, P2, P3, P4. For each arrangement of pixels, it is, for example, possible to reserve for a first pixel, for example for the first pixel P1 of the matrix of the display device, the light intensity signal S11 that makes it possible to display the first pixel P1 of the first image. It is possible to also reserve for a second pixel, for example the fourth pixel P4 of the matrix of the display device, the light intensity signal S14 that makes it possible to display the fourth pixel of the first image. Finally, it is possible to reserve for the other two pixels, that is to say, for example, the second and third pixels P2, P3 of the matrix of the display device, the signals intended for the pixels of the arrangement concerned of the second image that correspond thereto, that is, respectively, the light intensity signals S22 and S23. Such an exemplary arrangement is particularly suited to the cases where the second image is two-color. For example, colored filters can be assigned to the second and third pixels P2, P3 of all the arrangements of pixels of the matrix of the display device.

Advantageously, the colored filters associated with the second and third pixels P2, P3 may be of colors which, in combination, make it possible to visually restore the color associated with the first pixel P1. For example, the colored filters associated with the second and third pixels P2, P3 may be of two complementary colors, so that, by addition, they can restore the white color. The colored filters associated with the second pixels P2 of the arrangements forming the matrix of the display device may, for example, be of red color, and the filters associated with the third pixels P3 may, for example, be of cyan color.

Practically, the display of the duly merged image can, for example, be implemented via the following operations, performed by means of the controller of the display device:
a first operation of mapping the first image to the display device, the controller then applying the light intensity signals S11 and S14 respectively to the first and fourth pixels P1 and P4 of all the arrangements of pixels forming the display device;
a second operation of mapping the second image to the display device, the controller then applying the light intensity signals S22 and S23 respectively to the second and third pixels P2 and P3 of all the arrangements of pixels forming the display device. Since the second image consists of two colors, the mapping may consist in mapping the first color to the submatrix consisting of the second pixels P2, that is to say on a resolution corresponding to a quarter of the resolution of the matrix of the display device, and in the mapping of the second color to the submatrix consisting of the third pixels P3, that is to say on a resolution that also corresponds to a quarter of the resolution of the matrix of the display device.

Advantageously, for the pixels of the second image for which the light intensity signals S22 and S23 respectively for the second and third pixels P2 and P3 are below a determined threshold value, that is to say where the second image is not visible, or is only barely visible, the second operation may be replaced with an alternative operation. This alternative operation may consist in applying to the second and third pixels of the matrix of the display device, for example for the pixels of the matrix of the display device that correspond to pixels of the second image intended to be displayed with a signal for which the light intensity is situated below the threshold, light intensity signals for example determined by the controller, corresponding to a combination of the values of the light intensity signals S12 and S13 of the first image. For example, it is possible to apply to the pixels P2 and P3 respectively the signals S2 and S3, the values of which are defined by the following relationships:

S2=a*(S12+S13)/2,

S3=b*(S12+S13)/2;

a and b being real parameters, the sum of which equals 2.

Advantageously, the parameters a and b can be chosen so as to generate, by combining the light of the pixels P2 and P3, the same color as those of the pixels P1 and P4. It is obviously possible to envisage applying more complex formulae for the combination of the two signals S2 and S3, these being able to be linear or nonlinear relationships.

This may prove particularly advantageous when the useful part of the second image covers only a part of the surface thereof, notably in the case where the second image represents a symbol or textural information.

Also advantageously, means for reinforcing the contrast of the merged image may be implemented, for example by means of the controller of the display device.

In fact, the color or colors of the second image may appear saturated only on the parts of the merged image for which the background of the first image is relatively dark. On the lighter parts of the first image, the color of the pixels of the matrix of the display device conveying information relating to the second image, that is to say the second pixel P2 in the case of the first example mentioned above and illustrated in FIG. 2, or the second and third pixels P2 and P3 in the case of this second example mentioned above and illustrated FIG. 3, may appear with little saturation, that is to say visually appear like a pastel color. The means for reinforcing the contrast of the merged image may make it possible to obtain a good saturation of the colors of the second image while keeping a maximum display area for the first image.

Thus, the contrast reinforcement means may be configured so as to correct the display of the first image as follows, given as an example which is not limiting on the present invention: in the case of the first example mentioned above, for the second pixels P2 for which the light intensity signal is different from the light intensity signal corresponding to a black level, or else for which the quantified value is greater than a predetermined threshold value, it is possible to determine the quantified values of the light intensity signals S1, S3 and S4 to be applied respectively to the first, third and fourth pixels of the arrangements, for example according to the following relationship:

Si=b·exp(−a·S1i)·S1i, for i=1; 3; 4; (1)

in the case of the second example mentioned above, for the second and third pixels P2 and P3 for which the light intensity signal is different from the light intensity signal corresponding to a black level, or else for which the quantified value is greater than a predetermined threshold value, it is possible to determine the quantified values of the light intensity signals S1 and S4 to be applied respectively to the first and fourth pixels of the arrangements, for example according to the following relationship:

Si=b·exp(−a·S1i)·S1i, for i=1; 4, (2)

a and b in the relationships (1) and (2) above are parameters that can be defined and set by means of the controller according to the targeted applications, or even parameters than can be modified by a user, for example via external control means making it possible to modify the configuration of the controller.

It should be noted that other functions can be applied for the determination of the values of the signals to be applied, the important thing to remember here being that the function applied should allow for an attenuation of the light levels of the first image, without in any way attenuating too much the darker levels.

In practice, a display device according to one of the embodiments described previously may, for example, be based on a matrix display device associated with a controller, the controller being able, for example, to be integrated in the matrix, or else external thereto.

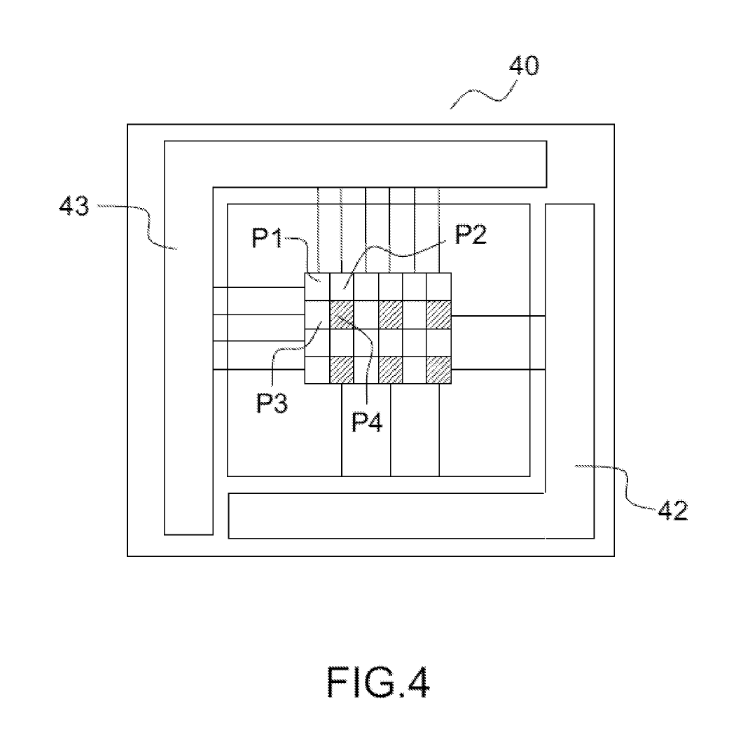

It is also possible, in an advantageous embodiment, for the display device to be based on a dedicated hardware architecture, notably offering an advantage in terms of lower consumption in operation. An exemplary hardware architecture may be based on a matrix of pixels associated with two controllers, as described hereinbelow with reference to FIG. 4, illustrating an exemplary embodiment of a matrix display device according to one embodiment of the invention.

A matrix display device 40 may, for example, comprise a mosaic of a plurality of arrangements of four pixels P1, P2, P3, P4. The matrix display device 40 is thus particularly suited to the first embodiment described previously with reference to FIG. 2.

A first controller 41, for example integrated in the structure containing the matrix, may be interfaced, via physical connection lines, with three pixels of each arrangement: the pixels P1, P2, P3 in the example illustrated in FIG. 4.

A second controller 42, for example also integrated in the structure containing the matrix, may be interfaced, via physical connection lines, with the remaining pixel of each arrangement: the pixel P4 in the example illustrated by the in FIG. 4.

In this way, a video stream intended for a display on the matrix display device 40 can be displaced in interleaved manner, in the form of a first video stream generated by the first controller 41, and of a second video stream generated by the second controller 42. In such a configuration, each pixel is formed by one or more pixels (three in the example illustrated in FIG. 4) driven by the first controller 41, and one or more pixels (one in the example of FIG. 4) being driven by the second controller 42. Generally, the pixels dedicated respectively to the display of the first and the second image may be designed so as to emit different colors, by being, for example, associated with filters of dedicated colors. For example, the pixels dedicated to the display of the first image may be designed so as to emit a single first color, the pixels dedicated to the display of the second image being designed so as to emit a single second color, different from the first color.

In a typical exemplary application, the displayed image may have a definition of 800×500 pixels, the first image having, for example, an identical definition and giving a monochrome illustration of the visible field, and the second image having, for example, a definition four times lower, that is to say 400×250 pixels², and illustrating, for example, the infrared field. In this typical configuration and according to the example illustrated in FIG. 4, the pixels P4 of the arrangements forming the matrix are, for example, associated with a filter of red color.

Another advantage obtained by such a device is that the two video streams generated by each of the two controllers 41, 42 can have different definitions. Similarly, the two video streams can have different refresh frequencies. This way, the overall consumption of the matrix display device 40 is minimized.

Practical exemplary embodiments of the present invention are described hereinbelow.

According to a first example, the image displayed by the matrix display device may combine a first image originating from a night vision sensor with a second graphical image, for example generated by a microcontroller or a microcomputer. The first image may, for example, be a monochrome image, with a definition of 2000×2000 pixels, the color displayed being, for example, white or a first color C1. The second image may consist of graphical information (for example, icons, cursors, menus, etc.) or textual information (position, time and other such information), the color displayed being, for example, red, or else a second color C2 different from the first color C1.

In this first example, the matrix display device may comprise a video controller, for example of FPGA type, a video interface with the night vision sensor, a video interface with the microcontroller or microcomputer for the display of the second image, an output interface with the matrix of pixels, the latter forming a dedicated display panel comprising arrangements of four pixels in squares. The definition of the matrix of pixels can then be 2000×2000 pixels, the arrangements of four pixels P1 to P4 consisting of three pixels P1, P3 and P4 emitting in the white color or in the first color C1, the remaining pixel P2 emitting in the red color or in the second color C2.

The matrix of pixels may be formed by a microdisplay of OLED type with active matrix with white emitters (or emitters in the first color C1), a red colored filter (or a filter of the second color C2) being associated with the pixels intended for the display of the second image, or else these pixels being associated with red emitters or emitters in the second color C2.

According to this first example, the combined display of the two images may then consist of a display of the first image on the matrix of 2000×2000 pixels with one pixel out of every four (the pixels P2) omitted. With S11, S12, S13 and S14 designating the intensity signals corresponding to the first image to be applied respectively to the pixels P1, P2, P3, P4, S11 is applied to the pixel P1, S13 to the pixel P3 and S14 to the pixel P4. The second image can then be displayed on the remaining pixels P2, by applying the signal S22 (intensity signal corresponding to the second image).

Depending on the intensity of the first image, the second image may appear more or less saturated. In this first example, the red of the second image may appear pink on a light background (that is to say, the first image). To compensate this phenomenon, a local correction of the intensity of the first image can be performed, around display areas of the second image, that is to say in places where the intensity of the second image is different from zero, or else is above a determined threshold. As is described previously, in order not to excessively degrade the color saturation, the signals S11, S13 and S14 may be attenuated so that the attenuation is maximum if the intensity is strong (white background), and negligible when the intensity is weak (dark background), for example:

if S22> determined threshold value, then:

S1i(corr)=exp(−a*S1i)*S1i, i=1, 3, 4,

a being a parameter to be determined according to the application. For example, if the image 2 contains symbols, a value of a of between 0.002 and 0.006 gives satisfactory results. Thus, the color of the first image remains fairly saturated, whereas the second image remains transparent; in other words, it is still possible to clearly distinguish the details of the first image behind the symbols of the second image.

According to a second example, the image displayed by the matrix display device may combine a first image originating from a night vision sensor with a second image derived from an infrared sensor targeting the same scene. The first image may, for example, be a monochrome image, with a definition of 2000×2000 pixels, the color displayed being, for example, white or a first color C1. The second image may also be monochrome, with a lower resolution: for example 480×480 pixels, the color displayed being, for example, red, or else a second color C2 different from the first color C1.

In this second example, the matrix display device may comprise a video controller, for example of FPGA type, a first video interface with the night vision sensor, a second video interface with the infrared sensor, an image processing unit for performing the mapping of the second image, that is to say, the adaptation of the definition thereof, dictated by the infrared sensor, to the resolution of the matrix of pixels reserved for the display of the second image (for example 1000×1000 pixels if one pixel in every four is used for this purpose, as is explained hereinbelow), an output interface with the matrix of pixels, the latter forming a dedicated display panel comprising arrangements of four pixels in squares. The definition of the matrix of pixels may then, like the first example described previously, be 2000×2000 pixels, the arrangements of four pixels P1 to P4 consisting of three pixels P1, P3 and P4 emitting in the white color or in the first color C1, the remaining pixel P2 emitting in the red color or in the second color C2.

The matrix of pixels may also be formed by a microdisplay of OLED type with active matrix with white emitters (or emitters in the first color C1), a red colored filter (or a filter of the second color C2) being associated with the pixels intended for the display of the second image, or else these pixels being associated with red emitters, or emitters in the second color C2.

The combined display of the two images can be produced in a way similar to the first example described previously. In order to obtain a good visibility on both images, it is important in this second example to apply the intensity correction to the first image from a certain threshold of intensity of the second image only, and to apply the parameter a appropriately.

It should be noted that all the embodiments described hereinabove apply to the combined display of two images. However, a matrix display device according to the present invention may also display a plurality of combined images, with arrangements of pixels in which pixels are dedicated to different images out of the plurality of images.

Thus, according to a third example, in a manner similar to the second example described previously, the image displayed by the matrix display device may combine a first image originating from a night vision sensor with a second image derived from an infrared sensor targeting the same scene, but also with a third image, for example generated by a microcontroller or a microcomputer, like the second image in the first example described previously. The first image may, for example, be a monochrome image, with a definition of 2000×2000 pixels, the color displayed being, for example, white or a first color C1. The second image may also be monochrome, with lower resolution: for example 480×480 pixels, the color displayed being, for example, red, or else a second color C2 different from the first color C1. The third image may consist of graphical information (for example, icons, cursors, menus, etc.) or textual information (position, time or other such information), the color displayed being, for example, cyan, or else a third color C3 different from the first color C1 and from the second color C2.

In the third example, the matrix display device may comprise a video controller, for example of FPGA type, a first video interface with the night vision sensor, a second video interface with the infrared sensor, a third video interface with the microcontroller or microcomputer for the display of the second image, an image processing unit for producing the mapping of the second image like in the second example described previously, an output interface with the matrix of pixels, the latter forming a dedicated display panel comprising arrangements of four pixels in squares. The definition of the matrix of pixels may then be 2000×2000 pixels, the arrangements of four pixels P1 to P4 consisting of two pixels P1 and P4 emitting in the white color or in the first color C1, the pixel P2 being dedicated to the display of the second image and emitting in the red color or in the second color C2, and the pixel P3 emitting in the cyan color or in the third color C3, and being dedicated to the display of the third image.

The matrix of pixels may be formed by a microdisplay of OLED type with active matrix with white emitters (or emitters in the first color C1), a red colored filter (or a filter of the second color C2) being associated with the pixels intended for the display of the second image, or else these pixels being associated with red emitters or emitters in the second color C2, a cyan colored filter (or filter of the third color C3) being associated with the pixels intended for the display of the third image, or else these pixels being associated with emitters in cyan or in the third color C3.

According to this third example, the combined display of the three images may then consist of a display of the first image on the matrix of 2000×2000 pixels with two pixels in every four (the pixels P2 and P3) omitted. With S11, S12, S13 and S14 designating the intensity signals corresponding to the first image to be applied respectively to the pixels P1, P2, P3, P4, S11 is applied to the pixel P1 and S14 to the pixel P4. The second image may then be displayed on the pixels P2, by applying the signal S22 (intensity signal corresponding to the second image), and the third image may be displayed on the pixels P3, by applying the signal S33.

Depending on the intensity of the first image, the second and third images may appear more or less saturated. Thus, the red of the second image may appear pink on a light background (that is to say, the first image). To compensate this phenomenon, a local correction of the intensity of the first image can be performed, around areas of display of the second and of the third images, that is to say in places where the intensity of the second or the third image is different from zero, or else is above a determined threshold. The signals S11 and S14 can thus be attenuated such that the attenuation is maximum if the intensity is strong (white background), and negligible when the intensity is weak (dark background), for example:
if S22> first determined threshold value OR S33> second determined threshold value, then:

S1i(corr)=exp(−a*S1i)*S1i, i=1, 4,

a being a parameter to be determined according to the application. For example, if the image 2 contains symbols, a value of a between 0.002 and 0.004 gives satisfactory results. Thus, the color of the first image remains fairly saturated, whereas the second and third images remain transparent.

In order to further enhance the efficiency of the first image, it is possible, as described previously, to use the pixels P2 and P3 for the display of the first image in places thereof where no overlay of the second or third image is present, or else in places of the first image where the intensity of the overlays remains below a determined threshold. By having chosen complementary colors for the pixels P2 and P3 of the arrangements, that is to say that their superimposition generates the white color, a combination of P2 and P3 may replace a white pixel. It is then possible to display on the pixels P2 and P3 the following signals:

if S22< third threshold value AND S33< fourth threshold value, then:

S2=(S12+S13)/2

S3=(S12+S13)/2

In this way, it is possible to profit from a maximum of resolution for the first image.

We claim:

1. A matrix display device with a definition determined by a plurality of pixels, the matrix display device comprising:
at least one controller suitable for producing display light intensity signals for each of the pixels; and
a matrix of pixels organized in a mosaic of a plurality of identical arrangements of a predetermined number of pixels, wherein
a first plurality of pixels of one of the arrangements are dedicated to display of a first image and receive the light intensity signals associated with the pixels of the first image that correspond thereto,
one or more other pixels of the arrangement are dedicated to display of a second image and receiving light intensity signals associated with the pixels of the second image that correspond thereto,
the matrix display device produces the merged display of the first image and of the second image, and
the two images are, if necessary, redimensioned by scaling means.

2. The matrix display device according to claim 1, wherein the first plurality of pixels emit a first single color, and the other pixels dedicated to the display of the second image emit a second single color different from the first color.

3. The matrix display device according to claim 1, wherein each of the arrangements comprises a square of four pixels comprising
three pixels associated with the light intensity signals intended for the corresponding pixels of the first image, and
a remaining pixel associated with the light intensity signal intended for the corresponding pixel of the second image.

4. The matrix display device according to claim 1, wherein each of the arrangements comprises a square of four pixels comprising
a first two pixels associated with the light intensity signals intended for the corresponding pixels of the first image, and
a second two pixels associated with the light intensity signals intended for the corresponding pixels of the second image.

5. The matrix display device according to claim 3, wherein the controller is configured to apply to the three pixels of each of the arrangements for which said remaining pixels have a quantified light intensity signal value greater than a predetermined threshold value, an attenuation function attenuating the quantified values of the signals to be applied.

6. The matrix display device according to claim 5, wherein the attenuation function attenuates the quantified values of the light intensity signals to be applied respectively to said three pixels, according to the following relationship:
Si=b·exp(−a·S1i)·S1i, for i=1; 3; 4, a and b being real parameters.

7. The matrix display device according to claim 4, wherein the controller is configured to apply to the first two pixels of each of the arrangements for which the second two pixels have a quantified light intensity signal value greater than a predetermined threshold value, an attenuation function attenuating the quantified values of the signals to be applied.

8. The matrix display device according to claim 7, wherein the attenuation function attenuates the quantified values of the light intensity signals to be applied respectively to the first two pixels, according to the following relationship:
Si=b·exp(−a·S1i)·S1i, for i=1; 4, a and b being real parameters.

9. The matrix display device according to claim 4, wherein the second two pixels of each arrangement are configured to display two colors which, by combination, make it possible to restore the color associated with the first image.

10. The matrix display device according to claim 9, wherein the controller is configured to apply, to the second two pixels of each of the arrangements of the display device for which the pixels of the arrangements of said second image that correspond thereto have a quantified light intensity value less than a determined threshold, values deriving from a combination of the quantified values of the light intensity signals S12 and S13 of the first image, according to the following relationships:
S2=a*(S12+S13)/2,
S3=b*(S12+S13)/2;
a and b being real parameters, the sum of which equals 2.

11. The matrix display device according to claim 1, further comprising:
a first controller interfacing with said first plurality of pixels of each arrangement and corresponding to the first image, and
a second controller interfacing with the other pixels of each arrangement and corresponding to said second image.

12. The matrix display device according to claim 1, wherein
the first image is an essentially monochrome image produced by a night vision sensor, an infrared sensor, or an X-ray imaging sensor, and
the second image is an essentially monochrome image produced by an infrared sensor, an echography sensor, or a monochrome or two-color symbology image.
